(19) United States
(12) Patent Application Publication
(10) Pub. No.: US 2021/0164602 A1
(43) Pub. Date: Jun. 3, 2021

(54) HYBRID PIPE HAVING PIPE COLLAR AND WEAR RING, AND METHOD FOR PRODUCING SAME

(71) Applicant: ESSER-WERKE GMBH & CO. KG, Warstein (DE)

(72) Inventors: Ruediger LUIG, Warstein (DE); Peter SPANKE, Warstein (DE)

(21) Appl. No.: 16/982,139

(22) PCT Filed: Aug. 21, 2019
(86) PCT No.: PCT/EP2019/057148

§ 371 Date: Jan. 7, 2021

(30) Foreign Application Priority Data
Mar. 21, 2018 (EP) 18163179.7

(51) Int. Cl. F16L 57/06; B65G 53/52

(52) U.S. Cl. CPC F16L 57/06; B65G 53/523

(57) ABSTRACT

A delivery pipe for transport of solids, having a double-walled pipe body having an inner pipe and a metallic outer pipe and at least one pipe collar arranged on an end. The delivery pipe is distinguished in that the inner pipe is made of a solid plastic material and a wear ring is inserted in the pipe collar, the inner diameter of which ring is less than or equal to the inner diameter of the inner pipe.

### RELATED APPLICATIONS

The present application is a National Phase of International Application Number PCT/EP2019/057148 filed Mar. 21, 2019, which claims priority to European Application Number 18163179.7 filed Mar. 21, 2018.

### FIELD

The present disclosure concerns a delivery pipe for the transport of solids, and a method for its production.

### BACKGROUND

It is known from the prior art to use delivery pipes for transporting solids. Such delivery pipes are used for example in concrete delivery pumps. The delivery pipes may firstly be designed pressure-resistant in order to withstand the delivery pressure. Secondly, because of the solid particles, a correspondingly high abrasive wear occurs.

Therefore the generic DE 198 21 637 A1 discloses a double-walled delivery pipe for the transport of solids. A pipe collar is applied at a respective end of the delivery pipe. A wear ring is arranged in the interior of the pipe collar.

Furthermore, US 2008/0174110 A1 describes a method for production of a dual-layer pipe. For this, a liner is produced by means of a casting process. During hardening, the liner shrinks. The liner is then removed from a casting mold, machined again and inserted in an outer pipe.

### SUMMARY

The object of the present disclosure is to optimize a generic delivery pipe, starting from the prior art, with respect to production costs, own weight, wear resistance and production suitability.

The above-mentioned object is achieved according to the disclosure.

Various exemplary embodiments of the present disclosure are described in the dependent claims.

The delivery pipe for the transport of solids is configured as a concrete delivery pipe. It has a double-walled pipe body which has an inner pipe and an outer pipe and at least one pipe collar coupled at the end. The delivery pipe according to the disclosure is distinguished in that the inner pipe is made of a plastic material and a wear ring is inserted in the pipe collar, the inner diameter of which ring is less than or equal to the inner diameter of the inner pipe, and the inner pipe is cast into the outer pipe in one casting process.

Firstly, an outer pipe is made from a pressure-resistant metallic material. This may for example be a steel of type S235 or also S355.

The outer pipe may also be made of fiber-reinforced composite material, for example GFRP or CFRP.

An inner pipe made of plastic is now cast directly into the outer pipe. For example, a polyurethane or polyurea plastic may be used for this. Here, also the inner pipe and outer pipe are coupled together by a substance-bonded coupling. For this, the inner pipe is cast into the outer pipe in the centrifugal casting process. This may be a rotational centrifugal casting or mold centrifugal casting. The wear rings inserted at the end ensure that during casting, no material from the inner pipe runs out of the outer pipe.

The plastic material of the inner pipe is selected such that the laminar flow occurring on the inner wall of the inner pipe provokes only a slight abrasive wear on the inner pipe. So as to minimize wear from turbulent flow in the transitional region between two pipes or between a pipe and a pipe elbow, here a wear ring is inserted.

The wear ring itself may also be formed as a plastic ring. Here a plastic material is selected which has a higher resistance to abrasive wear than the plastic of the inner pipe.

In various exemplary embodiments, the wear ring is made of a metallic material. The wear ring may also be hardened and tempered. It may for example be a steel of type C45 to C60. The wear ring may also be made of another cast material. For example, a chromium carbide material may be used here, for example GX350. Also, the wear ring may be made of a ceramic material.

So that the wear ring can be placed on the pipe end and the pipe can be coupled to further components, a pipe collar is formed at least on one end, for example, a pipe collar is formed on each end of the delivery pipe. The pipe collar itself is also made from a metallic material, and coupled to the outer pipe or produced integrally with the outer pipe. The coupling process used may be substance bonding, force fit or form fit, or a combination thereof. For example, soldering, welding, gluing, pressing or flanging may be used here. The pipe collar is welded to the outer pipe.

Because the inner pipe is made of plastic material, on soldering or welding, a heat transmission occurs via the outer pipe to the inner pipe, which could have negative effects on the plastic pipe. Accordingly, in the production method according to the disclosure, it is proposed that firstly the outer pipe is provided and coupled, or welded, to the pipe collar. Then the inner pipe may be introduced into the outer pipe without the plastic material of the inner pipe being negatively affected by the welding. For this, it is provided that an inner diameter of the pipe collar is greater than or equal to, or greater than, an outer diameter of the inner pipe or an inner diameter of the outer pipe. Despite the applied pipe collar therefore, tools can still be introduced into the outer pipe.

The wear ring itself may in turn be connected in the pipe collar. This may take place by form fit, interference fit and/or substance bonding. The wear ring is inserted by form fit on the principle of a clip connection. For this, the pipe collar has a radially circumferential wedge extension directed towards the inside. The wear ring has a corresponding radially circumferential wedge extension directed towards the outside. On insertion of the pipe collar, the chamfered faces of the wedge extensions abut each other until the respective wedge extension is overcome in the axial direction, so that the two wedge extensions on the pipe collar and wear ring engage one behind the other by form fit or form an undercut.

Optionally, additionally or alternatively, the wear ring may also be glued in or otherwise inserted into the pipe collar.

As an alternative embodiment variant, to produce the delivery pipe, it is provided that the outer pipe is formed protruding in the axial direction relative to the inner pipe. Thus the pipe collar may be welded to the outer pipe. Optionally and additionally, during the welding process, the outer pipe may be cooled with internal cooling. Following the joining process, the wear ring may be inserted in the pipe collar. Alternatively, firstly the wear ring may be coupled to the pipe collar. Then the wear ring coupled to the pipe collar is inserted in the outer pipe. In this case, the wear ring protrudes inward beyond the pipe collar in the axial direction into the delivery pipe, in the direction of the inner pipe. The wear ring thus achieves a centering effect in the radial direction, so that the pipe collar and outer pipe can be welded together.

To minimize the turbulent flow at the transition from the wear ring to the inner pipe, it is furthermore provided that the inner diameter of the pipe collar is less than or equal to the inner diameter of the inner pipe. A flow entering the inner pipe may, at a transition region from the wear ring to the inner part, be lifted in the radial direction so that the wear on the end region of the inner part is initially greater.

Furthermore, the wear ring has an axial length of between 30 and 200 mm. The axial length corresponds to approximately 25 to 100% of the inner diameter of the pipe collar itself.

The delivery pipe provided according to the disclosure, because of the plastic inner pipe, has a low own weight. Because of the wear rings in the inlet region, the durability of such a delivery pipe—which could also be described as a hybrid pipe—is also high. The production costs are low because of the production method described above, the materials used and the associated material costs.

According to the disclosure, the solids delivery pipe may also be produced such that the outer pipe is flared at the end. The flared end constitutes the pipe collar. The wear ring is then inserted in the flared outer pipe. Alternatively, also the inner pipe may be introduced into the outer pipe after insertion of the wear ring. The inner pipe here is introduced into the outer pipe in the centrifugal casting process. The wear ring introduced at the respective end then prevents the liquid material for production of the inner pipe from emerging at the end during the centrifugal casting process.

The end of the outer pipe may be flared in one stage, optionally also in two stages, i.e. with two stepped shoulders. The wear ring is inserted in the inner pipe. This may take place via pressing. Optionally, an outer ring may also be applied to the outer pipe on the outside. This then holds the wear ring in the outer pipe with a press fit.

The present disclosure furthermore concerns a method for production of the delivery pipe.

This method is distinguished in that the inner pipe is cast into the outer pipe. Casting takes place with a centrifugal casting process, and again with a rotational centrifugal casting or mold centrifugal casting process. In connection with the wear ring, this may at the same time serve as a type of sealing plug. Because of the centrifugal force during the centrifugal casting process, the plastic material for forming the inner pipe is pressed against the inner casing surface of the outer pipe. This takes place in the radial direction. At the same time however, at least partially, material for production of the inner pipe would run out at the axial ends of the outer pipe. This is prevented by the wear ring.

In various exemplary embodiments, a chemical and/or mechanical cleaning of the inner casing surface of the outer pipe is carried out before the plastic material is introduced. The plastic material here is introduced in a liquid or paste-like or viscous state. Then the outer pipe is rotated about its longitudinal axis and the inner pipe is thereby radially circumferentially produced in the outer pipe. In this way, wall thicknesses of the inner pipe can be produced between 1 and 20 mm, between 2 and 10 mm, and between 3 and 7 mm. The wall thickness of the inner pipe should however be considered independent of the production method, in contrast to pipes which are drawn or pushed in. This improves the delivery pipe in comparison with drawn or pushed inner pipes.

Production in the casting process at the same time creates a substance-bonded connection between the outer pipe and inner pipe. The outer pipe and inner pipe need not therefore be separately glued together again. The respective wear ring is also cast onto the inner pipe at the respective inner radial end face.

In various exemplary embodiments, the outer pipe is heated during filling and subsequent rotation for the centrifugal casting. The outer pipe may here be warmer than the inserted plastic material. This has a positive effect during the subsequent cooling process. Later shrinking of the plastic material thus begins at the contact face between the inner pipe and outer pipe, and not at the inner casing surface of the produced plastic pipe.

### BRIEF DESCRIPTION OF THE DRAWINGS

Further advantages, features, properties and aspects of the present disclosure are the subject of the description below. Various exemplary embodiments are depicted in the diagrammatic figures. These show:

FIG. 1 an end of a hybrid pipe according to the disclosure with applied pipe collar,

FIG. 2 an alternative embodiment variant according to FIG. 1 with outer pipe protruding in the axial direction beyond the inner pipe,

FIG. 3 an embodiment variant as an alternative to FIG. 2 with respect to the coupling of the pipe collar, and

FIG. 4 an alternative embodiment variant with a pipe collar produced at least partially integrally from the outer pipe.

In the figures, the same reference signs are used for the same or a similar components, although repeated description has been omitted for reasons of simplicity.

### DETAILED DESCRIPTION

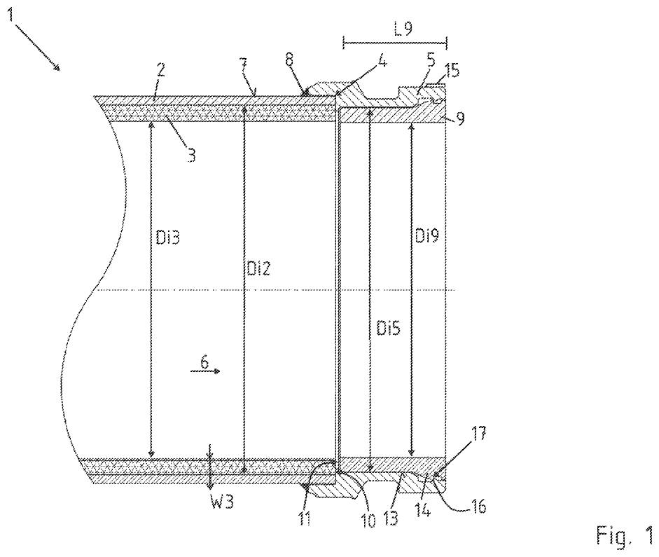

FIG. 1 shows an end portion of a delivery pipe 1 according to the disclosure, formed as a hybrid pipe or multilayer pipe with an outer pipe 2 and an inner pipe 3 encased in the outer pipe 2. According to the disclosure, the outer pipe 2 is made of a metallic material and the inner pipe 3 is made of a plastic material. A pipe collar 5 is placed on one end 4 of the delivery pipe 1. The pipe collar 5 here surrounds for example the outer casing surface 7 of the outer pipe 2 in the axial direction 6. Furthermore, the pipe collar 5 is coupled to the outer pipe 2 by substance bonding via a circumferential joining seam 8. The wall thickness W3 of the inner pipe is shown.

A wear ring 9 is inserted in the pipe collar 5. An inner diameter Di9 of the wear ring 9 is here made less than or equal to an inner diameter Di3 of the inner pipe 3. The face ends 10 and 11 of the wear ring 9 and inner pipe 3 abut each other without gaps.

Furthermore, an inner diameter Di5 of the pipe collar 5 is greater than or equal to an inner diameter Dig of the outer pipe 2. The wear ring 9 is also inserted in the pipe collar 5. For this, the wear ring 9 has a radially circumferential latching wedge 14 which protrudes from an outer casing surface 13 of the wear ring 9. An end 15 of the pipe collar 5 with enlarged inner diameter has an inwardly directed, radially circumferential wedge extension 16. If now the wear ring 9 is inserted in the pipe collar 5 in the axial direction 6, the wedge extensions 16 slide over each other and an undercut 17 is formed so that the wear ring 9 is positionally fixed by form fit. The wear ring 9 may alternatively be glued, pressed or flanged in place. The wear ring 9 furthermore has an axial length L9.

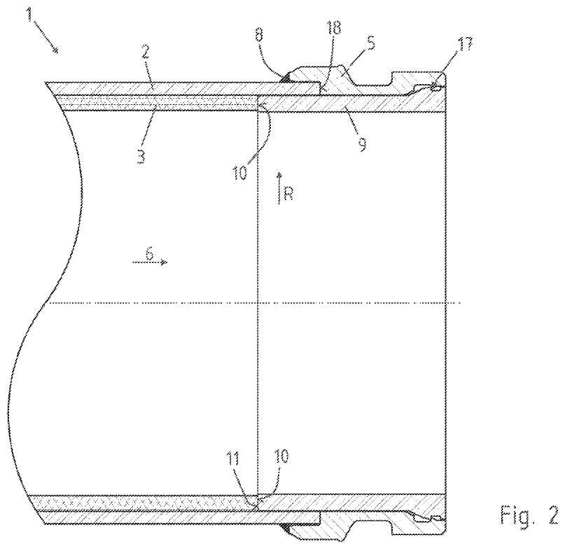

FIG. 2 shows an end portion of the delivery pipe 1. In contrast to FIG. 1, here the outer pipe 2 is formed protruding beyond the inner pipe 3 in the axial direction 6. The pipe collar 5 is again formed at least partially overlapping the outer pipe 2 in the axial direction 6, and is coupled to the outer pipe 2 by a joining seam 8. To ensure that any heat influence occurring does not negatively affect the plastic inner pipe 3, it is not the inner pipe 3 but a part of the wear ring 9 which is arranged in the region of the joining seam 8 below the outer pipe 2 with respect to the radial direction R. Corresponding heat effects during welding are not critical for the wear ring 9. Also, the wear ring 9 may be inserted only after completion of the joining seam 8. For example, the outer pipe 2 could be thermally cooled via an internal cooling (not shown in detail) during the welding process. In this embodiment variant, furthermore the end face 10 of the inner pipe 3 and the end face 11 of the wear ring 9 abut each other by form fit without gaps. In this embodiment variant too, the wear ring 9 is clipped into the pipe collar 5 by a corresponding undercut 17 between the wedge extensions. The wear ring 9 may however also be glued into the pipe collar 5, for example. The joining seam 8 is configured for example as a hollow weld.

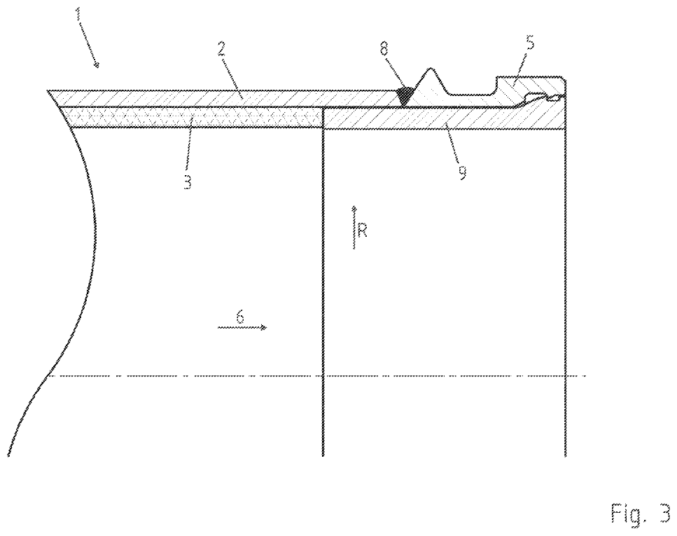

FIG. 3 shows an alternative embodiment variant to FIG. 1. Here, the outer pipe 2 in length portions protrudes beyond the inner pipe 3 in the axial direction 6. The pipe collar 5 is here coupled to the axial face end 18 of the outer pipe 2 by a joining seam 8 in the form of a butt weld. For example, this may be produced by inserting the wear ring 9 in the delivery pipe 1 together with the pipe collar 5 already applied. Centering in the radial direction R, of the pipe collar 5 to the outer pipe 2 is thus provided via the wear ring 9.

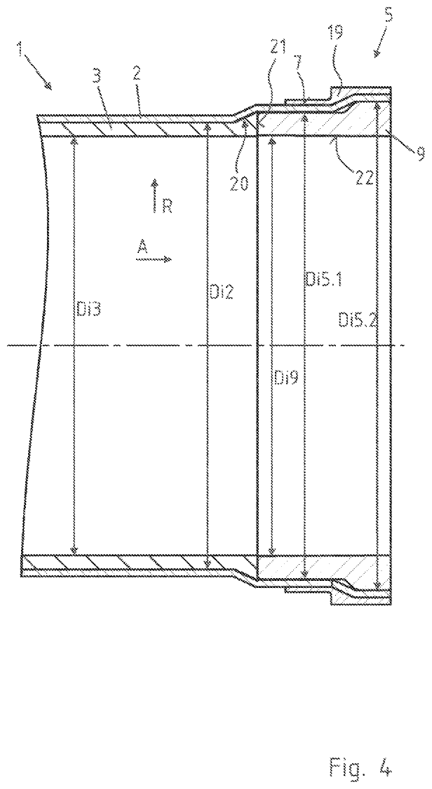

FIG. 4 shows an alternative embodiment variant of a delivery pipe 1. This also has an outer pipe 2 and an inner pipe 3. The inner pipe 3 is made of plastic material. The pipe collar 5 is produced at least partially integrally from the outer pipe 2. Here, the outer pipe 2 is flared. The flared end is formed in two stages. In comparison with an inner diameter Di2 of the outer pipe 2, the outer pipe 2 is flared in a first stage with an inner diameter Di5.1, and at the end again in a second stage with an inner diameter Di5.2, so that in each case a greater inner diameter Di5.1, Di5.2 results in comparison with the inner diameter Di2 of the outer pipe 2. A wear ring 9, made of a metallic material, is then inserted into the flared end. However, also a merely single-stage flaring of the outer pipe 2 may take place.

For further stabilization and fixing of the wear ring 9 and for an optional coupling possibility, an outer ring 19 is placed on the outside or outer casing surface 7 of the outer pipe 2. This outer ring 19 then helps form the flange 5. For production, first the outer ring 19 is pushed onto the outer pipe 2. Then the flaring is performed. Then the wear ring 9 is inserted at the end. In addition, the outer ring 19 is pushed over the end again in the axial direction A and pressed or otherwise connected, for example bonding may also be used. The outer ring 19 thus exerts an inwardly directed compression force in the radial direction R and thereby fixes the wear ring 9 because of the press fitting. This embodiment variant optionally offers the possibility that firstly the outer ring 2 with the pipe collar 5 is produced, wherein here the pipe collar 5 has the flared end, the wear ring 9 and outer ring 19. Then the inner pipe 3 may be introduced in the form of a plastic inner lining. This may for example be produced in the centrifugal casting process. In order to ensure that liquid casting material does not flow out of the pipe in the axial direction A during centrifugal casting, here the wear ring 9 is already inserted. Any plastic material of the inner pipe 3 thus also fills a shoulder 20 in the transitional region of the flared end. The material of the inner pipe 3 thus lies at the end on the wear ring 9, at an interface 21 between the wear ring 9 and inner pipe 3.

In all the above-mentioned embodiment variants, it is conceivable that a very thin-walled plastic layer or coating is formed on the inner casing surface 22 of the wear ring 9. This coating may serve as corrosion protection during storage or stocking of a delivery pipe 1 according to the disclosure. On first commissioning however, this coating is relatively quickly worn away by the abrasive behavior of the solid material to be transported, so that then the inner casing surface 22 of the wear ring 9 stands in direct contact with the solids to be delivered. A very short time after commissioning, for example, after a few conveying hours, thus the inner diameter Dig of the wear ring 9 is less than or equal to the inner diameter Di3 of the inner pipe 3. For production reasons (e.g. caused by overdosing), plastic may run over the inner diameter of the wear ring and this also form a thin layer.

In a further embodiment variant, the outer ring 19 may also be omitted so that only the wear ring 9 is inserted in the flared outer pipe 2.

For insertion of the wear ring 9, for example a thermal expansion may take place followed by insertion of the wear ring 9, in turn followed by a shrinking process. The wear ring 9 may also however be pressed into the flared outer pipe 2. Optionally, the outer ring 19 may then be applied.

The foregoing description of some embodiments of the disclosure has been presented for purposes of illustration and description. It is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. It should be understood that various changes, substitutions and alterations can be made hereto without departing from the spirit and scope of the disclosure.

1-15. (canceled)

16. A delivery pipe for transporting solids, the delivery pipe comprising:
a double-walled pipe body comprising an inner pipe and an outer pipe; and
at least one pipe collar arranged on an end of the outer pipe,
wherein the inner pipe comprises a plastic material, and a wear ring inserted into the at least one pipe collar,
wherein an inner diameter of the wear ring is less than or equal to an inner diameter of the inner pipe, and
wherein the inner pipe is cast into the outer pipe.

17. The delivery pipe according to claim 16, wherein the outer pipe comprises a pressure-resistant metallic material.

18. The delivery pipe according to claim 16, wherein the plastic material of the inner pipe comprises polyurethane.

19. The delivery pipe according to claim 16, wherein the wear ring comprises a plastic material having higher resistance to abrasive wear than the plastic material of the inner pipe.

20. The delivery pipe according to claim 16, wherein the wear ring comprises a hardened steel material, a cast material, or a ceramic material.

21. The delivery pipe according to claim 16, wherein the at least one pipe collar and the outer pipe are separate components.

22. The delivery pipe according to claim 16, wherein the at least one pipe collar surrounds the outer pipe in length portions in an axial direction of the delivery pipe.

23. The delivery pipe according to claim 16, wherein the wear ring is inserted in the at least one pipe collar so that a form-fit connection is established between (i) a radially circumferential latching wedge on an outer casing surface of the wear ring and (ii) a radially circumferential latching wedge on an inner casing surface of the at least one pipe collar.

24. The delivery pipe according to claim 16, wherein an inner diameter of the at least one pipe collar is greater than or equal to an inner diameter of the outer pipe.

25. The delivery pipe according to claim 16, wherein a face end of the outer pipe protrudes beyond a face end of the inner pipe in an axial direction of the delivery pipe.

26. The delivery pipe according to claim 25, wherein the wear ring engages the outer pipe so that the wear ring is arranged below a seam that joins the at least one pipe collar to the outer pipe in the axial direction of the delivery pipe.

27. The delivery pipe according to claim 25, wherein the wear ring is longer in the axial direction than the at least one pipe collar, so that the wear ring engages the outer pipe by form fit in the axial direction of the delivery pipe.

28. The delivery pipe according to claim 16, wherein the end of the outer pipe is flared, and the wear ring is inserted into the outer pipe.

29. The delivery pipe according to claim 28, further comprising an outer ring placed outside at the flared end of the outer pipe, wherein the outer ring holds the wear ring with a press fit.

30. A method of production of a delivery pipe, the delivery pipe comprising:
a double-walled pipe body comprising an inner pipe and an outer pipe, and
at least one pipe collar arranged on an end of the outer pipe,
wherein the inner pipe comprises a plastic material, and a wear ring inserted into the at least one pipe collar,
wherein an inner diameter of the wear ring is less than or equal to an inner diameter of the inner pipe, and
wherein the inner pipe is cast into the outer pipe, the method comprising:
inserting the wear ring at the end of the outer pipe,
introducing the plastic material of the inner pipe into the outer pipe, and then
casting the inner pipe in the outer pipe in a centrifugal casting process.

31. The delivery pipe according to claim 16, wherein the outer pipe comprises a fiber-reinforced composite material.

32. The delivery pipe according to claim 16, wherein the plastic material of the inner pipe comprises polyurea.

33. The delivery pipe according to claim 16, wherein the at least one pipe collar and the outer pipe are integrally configured from the same material.

34. The delivery pipe according to claim 16, wherein the outer pipe and inner pipe are connected by a substance-bonded connection between the outer pipe and inner pipe.
